(19) United States
(12) Patent Application Publication
(10) Pub. No.: US 2025/0187447 A1
(43) Pub. Date: Jun. 12, 2025

(54) BRAKING CONTROL DEVICE AND BRAKING CONTROL METHOD

(71) Applicants: TOYOTA JIDOSHA KABUSHIKI KAISHA, Toyota-shi (JP); ADVICS CO., LTD., Toyota-shi (JP)

(72) Inventors: Katsuhiro SUZUKI, Toyota-shi (JP); Naruto YAMANE, Susono-shi (JP); Hisanori MITSUMOTO, Hadano-shi (JP); Kazuma KURODA, Kariya-shi (JP); Shinya AKIBA, Kariya-shi (JP); Mako NOGUCHI, Kariya-shi (JP)

(73) Assignees: TOYOTA JIDOSHA KABUSHIKI KAISHA, Toyota-shi (JP); ADVICS CO., LTD., Toyota-shi (JP)

(21) Appl. No.: 18/934,899

(22) Filed: Nov. 1, 2024

(30) Foreign Application Priority Data
Dec. 7, 2023 (JP) 2023-206904

(51) Int. Cl. B60L 7/26

(52) U.S. Cl. CPC B60L 7/26; B60L 2240/12; B60L 2240/461; B60L 2240/465; B60L 2250/26

(57) ABSTRACT

A braking control device includes a derivation unit that derives the slip ratio of a wheel based on detected wheel speed and vehicle speed, a brake processor that determines braking amounts to be applied to a regenerative braking device and a friction braking device based on an accelerator operation amount and a braking operation amount, and a controller that controls the regenerative braking device and the friction braking device based on the determined braking amounts. When the slip ratio increases to a predetermined threshold value or more while the accelerator operation amount is decreasing, the controller executes target slip control for controlling torque of a motor of the regenerative braking device based on a predetermined target slip ratio to adjust the slip ratio, and when the target slip control is executed to perform the braking operation, the friction braking device generates a braking amount corresponding to the braking operation amount.

### CROSS-REFERENCE TO RELATED APPLICATION

This application claims priority to Japanese Patent Application No. 2023-206904 filed on Dec. 7, 2023, incorporated herein by reference in its entirety.

### BACKGROUND

### 1. Technical Field

The present disclosure relates to braking control using a friction braking device capable of applying frictional force to a wheel and a regenerative braking device including a motor.

### 2. Description of Related Art

Japanese Unexamined Patent Application Publication No. 2014-73709 discloses a braking control device in which vehicle control means performs coasting regenerative braking control of reducing coasting regenerative braking torque in a case where slippage exceeding a set value occurs in drive wheels when the vehicle control means performs coasting regenerative braking in a coasting state.

### SUMMARY

In a technique disclosed in JP 2014-73709 A, when slippage exceeding a set value occurs in wheels, coasting regenerative braking torque is reduced, which causes a risk that a recovery amount of regenerative electric power decreases. Furthermore, it is not desirable that slippage of the wheels increases.

An object of the present disclosure is to provide a technique that ensures the recovery amount of regenerative electric power while slippage of wheels is restrained.

According to an aspect of the present disclosure, a braking control device that controls a regenerative braking device provided for a regenerative braking wheel of any one of a front wheel and a rear wheel, and a friction braking device that is enabled to individually control friction braking force to be applied to each of the front wheel and the rear wheel includes an acquisition unit that acquires a detection result obtained by detecting an accelerator operation amount of an accelerator pedal, a detection result obtained by detecting a braking operation amount of a brake pedal, a detection result obtained by detecting wheel speeds of the front wheel and the rear wheel, and a detection result obtained by detecting a vehicle speed, a derivation unit that derives a slip ratio of a wheel based on detected wheel speed and vehicle speed, a brake processor that determines braking amounts to be applied to the regenerative braking device and the friction braking device based on the accelerator operation amount and the braking operation amount, and a controller that controls the regenerative braking device and the friction braking device based on the determined braking amounts. When the slip ratio increases to be equal to or more than a predetermined threshold value while the accelerator operation amount is decreasing, the controller controls the torque of a motor of the regenerative braking device based on a predetermined target slip ratio to execute target slip control of adjusting the slip ratio, and when the target slip control is executed and a braking operation is executed, the controller causes the friction braking device to generate a braking amount corresponding to a braking operation amount.

Another aspect of the present disclosure is a braking control method. This method is a braking control method in which individual steps are executed by a braking control device that controls a regenerative braking device provided for a regenerative braking wheel of any one of a front wheel and a rear wheel, and a friction braking device that is enabled to individually control friction braking force to be applied to each of the front wheel and the rear wheel, the braking control method including the steps of: acquiring a detection result obtained by detecting an accelerator operation amount of an accelerator pedal, a detection result obtained by detecting a braking operation amount of a brake pedal, a detection result obtained by detecting wheel speeds of the front wheel and the rear wheel, and a detection result obtained by detecting a vehicle speed; deriving a slip ratio of a wheel based on detected wheel speed and vehicle speed; determining braking amounts to be applied to the regenerative braking device and the friction braking device based on the accelerator operation amount and the braking operation amount; and controlling the regenerative braking device and the friction braking device based on the determined braking amount, wherein in the step of controlling, when the slip ratio increases to be equal to or more than a predetermined threshold value while the accelerator operation amount is decreasing, torque of a motor of the regenerative braking device is controlled based on a predetermined target slip ratio to execute target slip control of adjusting the slip ratio, and when the target slip control is executed and a braking operation is executed, the friction braking device is caused to generate a braking amount corresponding to the braking operation amount.

According to the present disclosure, it is possible to provide a technique that ensures the recovery amount of regenerative electric power while restraining slippage of wheels.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a functional configuration of a braking system;

FIG. 2A is a diagram showing braking control when target slip control is executed;

FIG. 2B is a diagram showing braking control when target slip control is executed;

FIG. 2C is a diagram showing braking control when target slip control is executed;

FIG. 2D is a diagram showing braking control when target slip control is executed;

FIG. 3A is a diagram showing braking control when target slip control is not executed;

FIG. 3B is a diagram showing braking control when target slip control is not executed;

FIG. 3C is a diagram showing braking control when target slip control is not executed;

FIG. 3D is a diagram showing braking control when target slip control is not executed;

FIG. 4 is a diagram showing the relation between front wheel deceleration and rear wheel deceleration when regenerative braking wheels are rear wheels; and

FIG. 5 is a flowchart of a braking control method of an example.

### DETAILED DESCRIPTION OF EMBODIMENTS

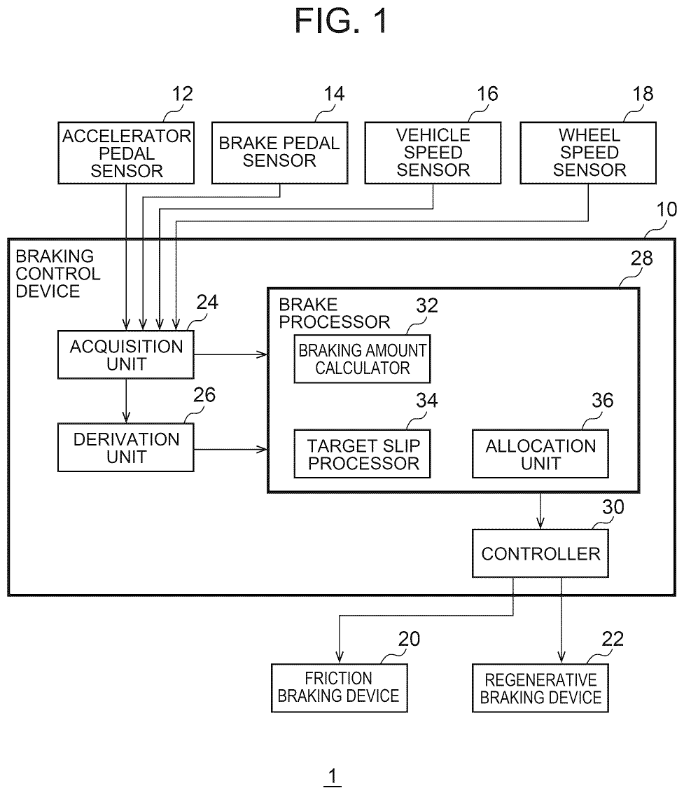

FIG. 1 is a diagram showing a functional configuration of a braking system 1. In terms of hardware, each function of the braking system 1 can be configured with a circuit block, a memory, and other LSIs, and in terms of software, it is implemented by system software and application programs loaded into the memory. Therefore, it is understood by those skilled in the art that each function of the braking system 1 can be implemented in various forms by only hardware, only software, or a combination of both the hardware and the software, and it is not limited to any one of them. The braking system 1 is provided in a vehicle, and the vehicle may perform autonomous driving.

The braking system 1 includes a braking control device 10, an accelerator pedal sensor 12, a brake pedal sensor 14, a vehicle speed sensor 16, a wheel speed sensor 18, a friction braking device 20 and a regenerative braking device 22.

The accelerator pedal sensor 12 detects the operation amount of an accelerator pedal, and transmits the detection result to the braking control device 10. The brake pedal sensor 14 detects the operation amount of brake pedal, and transmits the detection result to the braking control device 10. The accelerator pedal sensor 12 and the brake pedal sensor 14 are, for example, stroke sensors for detecting the amount of pedal depression. Note that the operation amount of the brake pedal can also be detected even when a sensor for detecting master cylinder pressure is used instead of the brake pedal sensor 14.

The vehicle speed sensor 16 detects a vehicle speed, and transmits the detection result to the braking control device 10. The wheel speed sensor 18 is provided for each wheel to detect the wheel speed of each wheel and transmit the detection result to the braking control device 10. The vehicle is provided with other on-vehicle sensors to be used for brake control. For example, the vehicle is provided with a sensor for detecting the deceleration of the vehicle, a sensor that is provided in the regenerative braking device 22 to detect the torque of the motor.

The friction braking device 20 is provided for each wheel, and can individually control friction braking force to be applied to each of the front and rear wheels. The friction braking device 20 moves a piston back and forth with hydraulic pressure, and presses a brake pad against a brake disc by advancement of the piston, thereby applying braking force to the wheel.

The regenerative braking device 22 is provided for a regenerative braking wheel of either the front wheels or the rear wheels. The regenerative braking wheel may be, for example, the rear wheel. The regenerative braking device 22 includes a motor, an inverter, and a battery. The motor is capable of generating a driving torque for rotating the wheel, and providing a regenerative torque to the rotation of the regenerative braking wheel when the vehicle decelerates. The regenerative electric power generated by the regenerative torque of the motor is charged into the battery. The regenerative torque can be adjusted by the control of the inverter.

The braking control device 10 controls the friction braking device 20 and the regenerative braking device 22 based on the detection results of various on-vehicle sensors. The braking control device 10 includes an acquisition unit 24, a derivation unit 26, a brake processor 28, and a controller 30.

The acquisition unit 24 acquires a detection result of the accelerator operation amount of the accelerator pedal, a detection result of the braking operation amount of the brake pedal, detection results of the wheel speeds of the front and rear wheels, and a detection result obtained by detecting the vehicle speed. The acquisition unit 24 also acquires a detection result from a sensor for detecting the torque of the regenerative braking device 22 and a sensor for detecting the deceleration of the vehicle.

The derivation unit 26 derives the slip ratio of each wheel based on the detected wheel speed and the vehicle speed. The slip ratio of the wheel defines the ratio of the difference between the vehicle speed and the wheel speed to the vehicle speed.

The brake processor 28 includes a braking amount calculator 32, a target slip processor 34, and an allocation unit 36. The braking amount calculator 32 determines a braking amount to be applied to the regenerative braking device 22 and the friction braking device 20 based on the accelerator operation amount and the braking operation amount. The braking amount calculator 32 may severally determine each of the braking amount corresponding to the accelerator operation amount and the braking amount corresponding to the braking operation amount. The braking amount may be torque or deceleration.

The braking amount calculator 32 determines regenerative torque to be generated as the braking amount corresponding to the accelerator operation amount by the regenerative braking device 22 while the accelerator operation amount is decreasing, that is, during coasting. When the accelerator operation amount is decreasing, the regenerative torque is generated by the regenerative braking device 22 to obtain regenerative electric power.

The target slip processor 34 decides to execute target slip control. The target slip control is control for controlling the torque of the motor of the regenerative braking device 22 based on a predetermined target slip ratio to adjust the slip ratio. The target slip processor 34 decides to execute the target slip control when the slip ratio of the wheel increases to be equal to or more than a predetermined threshold value while the accelerator operation amount is decreasing, that is, during coasting. The case where the slip ratio of the wheel increases to be equal to or more than the predetermined threshold value may be a case where the average value of the slip ratios of the wheels is equal to or more than a predetermined threshold value, or the slip ratio of any one of the wheels is equal to or more than a predetermined threshold value. The predetermined threshold value is set to a value smaller than a slip ratio at which the anti-lock brake system (ABS) starts to operate. For example, the slip ratio at which the ABS starts to operate is about 12%, and the target slip control is executed before the ABS starts to operate, and is controlled to maintain a target slip ratio smaller than 12%. The controller 30 controls the torque of the motor of the regenerative braking device 22 such that the slip ratio of the wheel maintains a predetermined target slip ratio. The target slip ratio may be a predetermined fixed value, or may be made variable depending on a vehicle state quantity such as vehicle speed or yaw rate, or a driver operation amount such as steering.

In the target slip control, the controller 30 adjusts the regenerative torque of the regenerative braking device 22 to obtain regenerative electric power while allowing the slip ratio of the wheel at a certain rate. The target slip control is executed when the slip ratio of the wheel is equal to or more than a predetermined threshold value, and thus it is performed in a situation where slip is likely to occur due to the influence of rain or snow. The target slip control stabilizes traveling by making it difficult to execute ABS, so that it is possible to ensure regenerative electric power. The target slip control is terminated when a series of braking control ends. The series of braking control means a process during which the accelerator operation amount starts to decrease due to release of the accelerator pedal, then the braking operation amount increases due to depression of the brake pedal, and finally the braking operation amount is equal to zero due to release of the brake pedal.

The braking amount calculator 32 calculates the braking amount corresponding to the braking operation amount. The allocation unit 36 allocates the braking amounts to be generated by the friction braking device 20 and the regenerative braking device 22 according to the determined braking amount. When a traveling state and a traveling environment of the vehicle are well conditioned, the regenerative braking device 22 is allocated in preference to the friction braking device 20. Under the control of preferentially allocating the regenerative braking device 22, the allocation unit 36 allocates the braking amount up to the maximum regeneration amount of the regenerative braking device 22, and compensates for an insufficient braking amount with the friction braking device 20. The controller 30 controls the regenerative braking device 22 and the friction braking device 20 based on the braking amount determined by the brake processor 28.

When the target slip control is executed and the braking operation amount increases, the allocation unit 36 generates the braking amount corresponding to the braking operation amount only by the friction braking device 20. The regenerative torque which has been obtained under the target slip control when the braking operation is turned on may be maintained or decreased, but the regenerative torque is restricted from increasing. This makes it possible to stabilize the braking control. An operation during execution of the target slip control will be described with reference to new drawings.

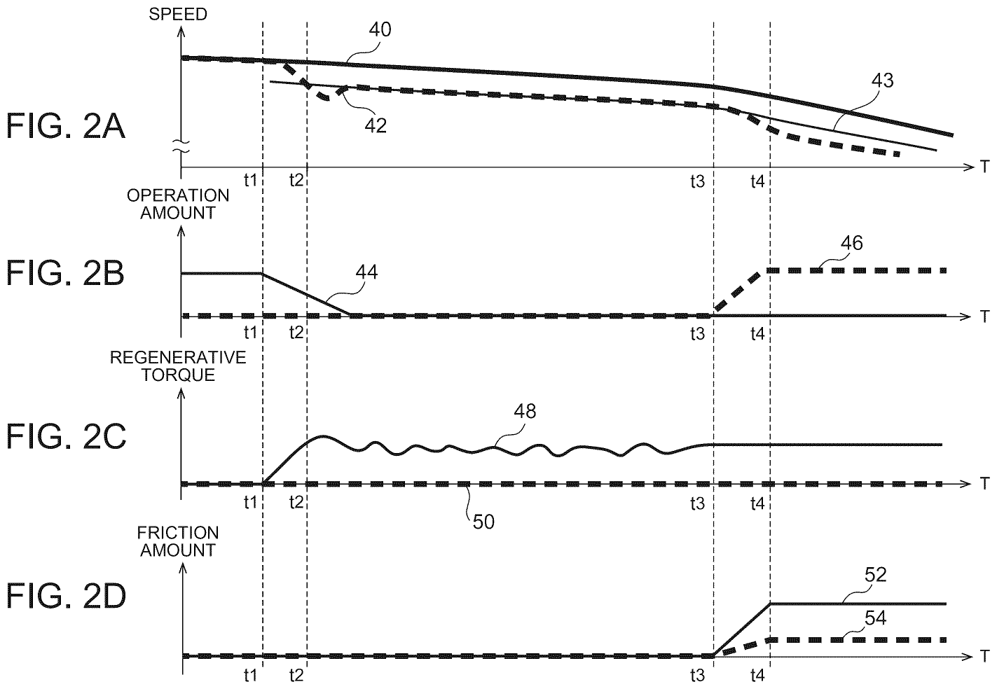

FIG. 2A, FIG. 2B, FIG. 2C, and FIG. 2D are diagrams showing braking control when target slip control is executed. The horizontal axes in FIG. 2A to FIG. 2D represent the time, and times of time t1 to time t4 represent the same times from FIG. 2A to FIG. 2D.

The vertical axis of FIG. 2A represents the speed, and shows a vehicle speed 40 and a wheel speed 42. The vertical axis of FIG. 2B represents the operation amount, and shows an accelerator operation amount 44 and a braking operation amount 46. The vertical axis of FIG. 2C represents the regenerative torque, and shows accelerator regenerative torque 48 and brake regenerative torque 50. The vertical axis of FIG. 2D represents the friction amount, and shows a front wheel friction amount 52 and a rear wheel friction amount 54.

FIG. 2B shows that the accelerator operation amount 44 starts to decrease from time t1, and FIG. 2C shows that the accelerator regenerative torque 48 starts to increase from time t1. At this time, the friction braking device 20 is not operating as shown in FIG. 2D. FIG. 2A shows that the wheel speed 42 starts to deviate from the vehicle speed 40 from time t1, and at time t2 the slip ratio is equal to or more than a predetermined threshold value, and target slip control is started.

FIG. 2C shows a waveform in which the accelerator regenerative torque 48 increases and decreases within a certain range from time t2 to time t3 as a result of the start of the target slip control. FIG. 2A shows that the wheel speed 42 decreases along a target slip value 43 as a result of the start of the target slip control, so that the difference between the wheel speed 42 and the vehicle speed 40 is kept constant. During the target slip control from time t2 to time t3, the friction braking device 20 is not operated. The period from time t2 to time t3 includes an idle traveling time during which the accelerator is switched to the brake, and FIG. 2B shows that the braking operation amount 46 starts to increase from time t3.

In FIG. 2D, the front wheel friction amount 52 and the rear wheel friction amount 54 increase in connection with an increase in the braking operation amount 46 from time t3, but in FIG. 2C, the accelerator regenerative torque 48 does not increase, and the brake regenerative torque 50 does not increase either. The accelerator regenerative torque 48 corresponds to the accelerator operation amount, and the brake regenerative torque 50 corresponds to the braking operation amount. The accelerator regenerative torque 48 is constant from time t3, and the target slip control is terminated. In this way, when the target slip control is executed, braking force is added only by the friction braking device 20 for the subsequent braking operation. As a result, it is possible to control the regenerative torque such that the regenerative torque is continuous within a certain range from the target slip control, and in a situation where slip occurs, the friction braking device 20 applies braking to restrain the slip ratio from increasing.

Although the front wheel friction amount 52 from time t3 is larger than the rear wheel friction amount 54, the hydraulic pressures at which the front-wheel friction braking devices 20 and the rear-wheel friction braking devices 20 operate are equal to each other, which makes it possible to simplify the braking control.

From time t3, the front wheel friction amount 52 and the rear wheel friction amount 54 start to increase simultaneously with each other, but the controller 30 may start to increase the front wheel friction amount 52 antecedently to the rear wheel friction amount 54, and then increase the rear wheel friction amount 54 a little later. Note that the rear wheels are regenerative braking wheels, and the front wheels are non-regenerative braking wheels.

When the regenerative braking wheel is not limited to the rear wheel, the following applies. When the target slip control is executed and the braking operation is executed, the controller 30 causes the friction braking devices 20 that do not correspond to the regenerative braking wheels among the friction braking devices 20 corresponding to the front and rear wheels to generate braking amounts in preference to the friction braking devices 20 corresponding to the regenerative braking wheels. Since the regenerative braking wheel is given braking force by the regenerative braking device 22, by preferentially applying braking force to the non-regenerative braking wheel, it is possible to restrain the imbalance of the braking force between the front and rear wheels at the beginning of the braking operation.

When the braking control device 10 tries to obtain the regenerative torque at the maximum in a bad road-surface situation, there is a risk that the slip ratio increases and ABS is activated early. The difference between the wheel speed 42 and the vehicle speed 40 becomes slightly larger due to the braking operation from time t3, but the regenerative torque does not increase, so that the slip ratio is restrained from increasing.

Returning to FIG. 1, the allocation unit 36 causes the control, of limiting the braking amount to be generated by the regenerative braking device 22, to be executed if the absolute value of the difference in slip ratio between the front and rear wheels is equal to or more than a predetermined value when the braking operation amount increases after no target slip control is executed during a decrease of the accelerator operation amount. Control to be executed in a situation where slip occurs due to braking operation without executing the target slip control will be described with reference to new drawings.

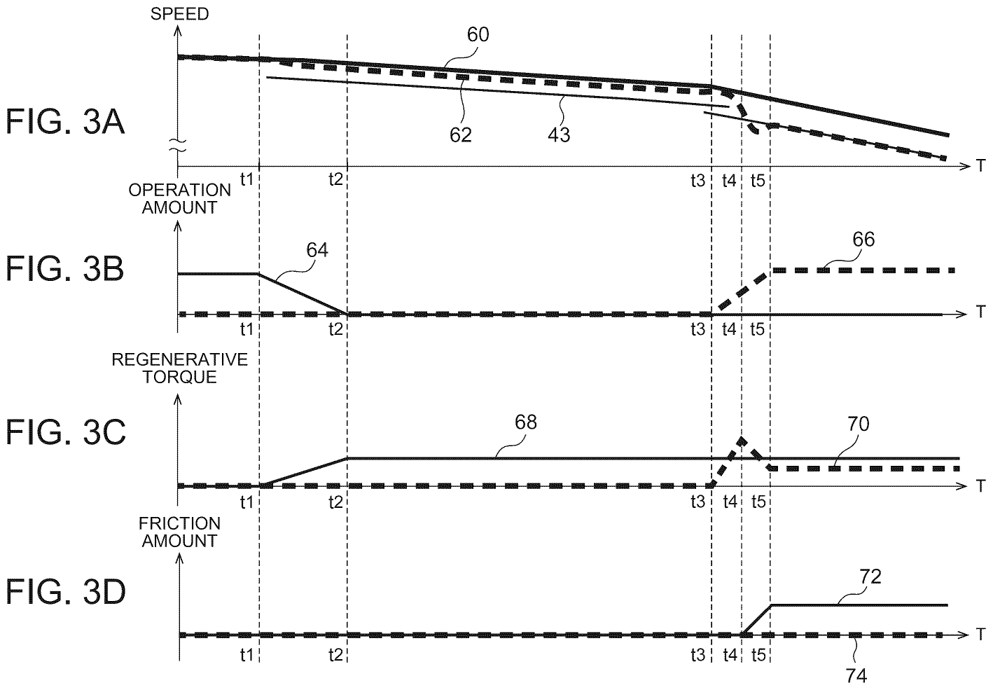

FIG. 3A, FIG. 3B, FIG. 3C, and FIG. 3D are diagrams showing braking control when target slip control is not executed. The horizontal axes of FIG. 3A to FIG. 3D represent the time, and the times of time t1 to time t5 are the same times from FIG. 3A to FIG. 3D.

The vertical axis of FIG. 3A represents the speed, and shows a vehicle speed 60 and a wheel speed 62. The vertical axis of FIG. 3B represents the operation amount, and shows an accelerator operation amount 64 and a braking operation amount 66. The vertical axis of FIG. 3C represents the regenerative torque, and shows an accelerator regenerative torque 68 and a brake regenerative torque 70. The vertical axis of FIG. 3D represents the friction amount, and shows a front wheel friction amount 72 and a rear wheel friction amount 74.

FIG. 3B shows that the accelerator operation amount 64 starts to decrease from time t1, and FIG. 3C shows that the accelerator regenerative torque 68 starts to increase from time t1. At this time, the friction braking device 20 is not operating as shown in FIG. 3D. FIG. 3A shows that the wheel speed 62 slightly deviates from the vehicle speed 60 from time t1, but the target slip control is not executed because the slip ratio is small.

At time t2, the accelerator operation is turned off. In FIG. 3C, the accelerator regenerative torque 68 increases between time t1 and time t2, and becomes a constant value after time t2. The period between time t2 and time t3 is an idle traveling time when the accelerator is switched to the brake, during which constant accelerator regenerative torque 68 is applied, and the vehicle speed 60 and wheel speed 62 decrease.

From time t3, the braking operation amount 66 in FIG. 3B starts to increase, the brake regenerative torque 70 in FIG. 3C starts to increase, and the front wheel friction amount 72 and the rear wheel friction amount 74 in FIG. 3D do not increase. This is because the regenerative braking of the regenerative braking device 22 is performed in preference to the friction braking device 20.

In FIG. 3A, from time t3, the wheel speed 62 starts to deviate from the vehicle speed 60, and when the absolute value of the difference in slip ratio between the front and rear wheels is equal to or more than a predetermined value at time t4, the brake processor 28 decides to limit the braking amount to be generated by the regenerative braking device 22. Therefore, from time t4, the brake regenerative torque 70 starts to decrease, and the front wheel friction amount 72 starts to increase.

At time t5, the increase of the braking operation amount 66 stops, the decrease of the brake regenerative torque 70 stops, and the increase of the front wheel friction amount 72 stops. In FIG. 3A, from time t4, the wheel speed 62 deviates from the vehicle speed 60 and the slip ratio increases, but the proportion of the friction braking to the regenerative braking is increased, whereby the slip ratio decreases and falls within an allowable value at time t5. In this way, if the slip ratio increases due to the braking operation in a case where the target slip control is not executed, it is possible to reduce the slip ratio by reducing the proportion of the regenerative braking.

A condition for restricting the regenerative braking at time t4 is determined based on the absolute value of the difference in slip ratio between the front and rear wheels, whereby it is possible to start restriction of the regenerative braking at a timing when slippage occurs surely while making it difficult to execute restriction of the regenerative braking. Note that the condition for restricting the regenerative braking at time t4 may be satisfied when the slip ratio of the wheel is equal to or more than a predetermined threshold value. In other words, when a predetermined condition indicating that the slip ratio of the wheel has increased to be equal to or more than a set value after no target slip control is executed, the brake processor 28 decides to restrict the braking amount to be generated by the regenerative braking device 22.

From time t4, the brake processor 28 sets a limiting value for the braking amount of the regenerative braking device 22, and the controller 30 controls the brake regenerative torque 70 such that the brake regenerative torque 70 is equal to or less than the limiting value. The limiting value for the braking amount of the regenerative braking device 22 is set based on the slip ratio of the regenerative braking wheel. The slip ratio of the regenerative braking wheel may be the average value of the slip ratios of the left and right wheels, or may be the slip ratio of any one of the left and right wheels. The limiting value for the braking amount of the regenerative braking device 22 decreases as the slip ratio of the regenerative braking wheel increases, and when the slip ratio of the regenerative braking wheel is equal to or more than a predetermined threshold value, the limiting value of the regenerative braking device 22 is equal to zero, so that the brake regenerative torque 70 is limited to be equal to zero.

As shown in FIG. 3C, even when the brake regenerative torque 70 is limited from time t4, the accelerator regenerative torque 68 remains a constant value. This makes it possible to restrain the regenerative torque from changing suddenly. When the brake regenerative torque 70 is limited, the accelerator regenerative torque 68 may also be gradually reduced. Here, the decrease amount of the accelerator regenerative torque 68 does not need to be compensated by the friction braking device 20.

At time t4, limitation on the braking amount of the regenerative braking device 22 is started, but when the increase of the slip ratio from time t3 is rapid, the limitation on the braking amount of the regenerative braking device 22 may not be capable of restraining the operation of ABS. Therefore, in a braking operation after no target slip control is executed, the brake processor 28 limits the increase amount of the brake regenerative torque 70 per unit time according to the increase rate of the braking operation amount 66 and the slip ratio.

Returning to FIG. 1, the braking amount calculator 32 allocates the braking amounts to the front and rear wheels according to a preset allocation ratio. The allocation unit 36 allocates the braking amount allocated to the regenerative braking wheel to the friction braking device 20 and the regenerative braking device 22.

The braking control device 10 can stabilize braking by distributing more braking force to the front wheels than that to the rear wheels. When the rear wheels are regenerative braking wheels, the accelerator regenerative torque is preferentially applied to the rear wheels, and further braking force caused by a braking operation is applied to the rear wheels. Therefore, at the beginning of braking, the braking force of the rear wheels is greater than that of the front wheels, which causes a risk that the slip ratio of the rear wheels increases depending on the traveling state and traveling environment of the vehicle. Therefore, the brake processor 28 varies the distribution in braking amount between the front and rear wheels at the beginning of braking caused by the braking operation, and more braking force is distributed to the front wheels than the rear wheels. This process will be described with reference to new drawings.

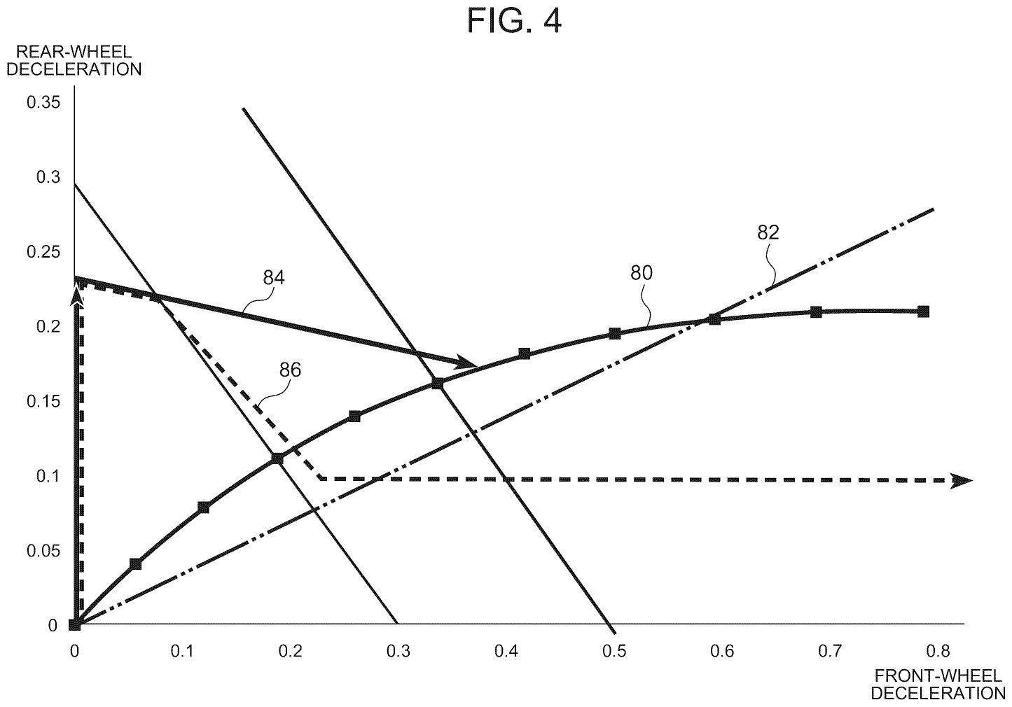

FIG. 4 is a diagram showing the relation between front wheel deceleration and rear wheel deceleration when the regenerative braking wheel is the rear wheel. The vertical axis of FIG. 4 represents the rear wheel deceleration, and the horizontal axis represents the front wheel deceleration. When the braking control device 10 applies braking force, it is desirable to be close to an ideal distribution line 80 or an equal-pressure brake distribution line 82. The ideal distribution line 80 shows the ideal distribution of deceleration, and the equal-pressure brake distribution line 82 shows the distribution when the friction braking devices 20 of the front and rear wheels are controlled with equal pressure.

In the case where the regenerative braking wheel shown in FIG. 4 is the rear wheel, in a deceleration distribution transition 84 of a comparative example, the deceleration of the rear wheels increases due to accelerator regenerative torque, and the deceleration distribution transition 84 shifts to be closer to the ideal distribution line 80 due to start of the braking operation.

In a braking amount distribution transition 86 of an example, the deceleration of the rear wheels increases due to the accelerator regenerative torque, and when the braking operation is started, braking force is applied to the front and rear wheels. At this time, if the braking operation amount, the accelerator regenerative torque, and the deceleration of the vehicle satisfy a predetermined condition, the brake processor 28 sets the deceleration of the rear wheels to a predetermined deceleration, and makes up for the shortfall using the front wheels. The controller 30 gradually decreases the deceleration of the rear wheels such that the deceleration of the rear wheels is equal to a predetermined deceleration, and when the deceleration of the rear wheels has reached the predetermined deceleration, the controller 30 stops the gradual decrease, and maintains the deceleration of the rear wheels. The predetermined condition is satisfied if the braking operation amount and the accelerator regenerative torque are equal to or more than predetermined torques, the deceleration of the vehicle is equal to or more than predetermined torque, and the brake regenerative torque is equal to or more than a predetermined value, and for example, it is satisfied when the vehicle is traveling on a highway. In this way, when the braking operation amount is large and a large deceleration is applied to the vehicle, the deceleration of the rear wheels can be reduced.

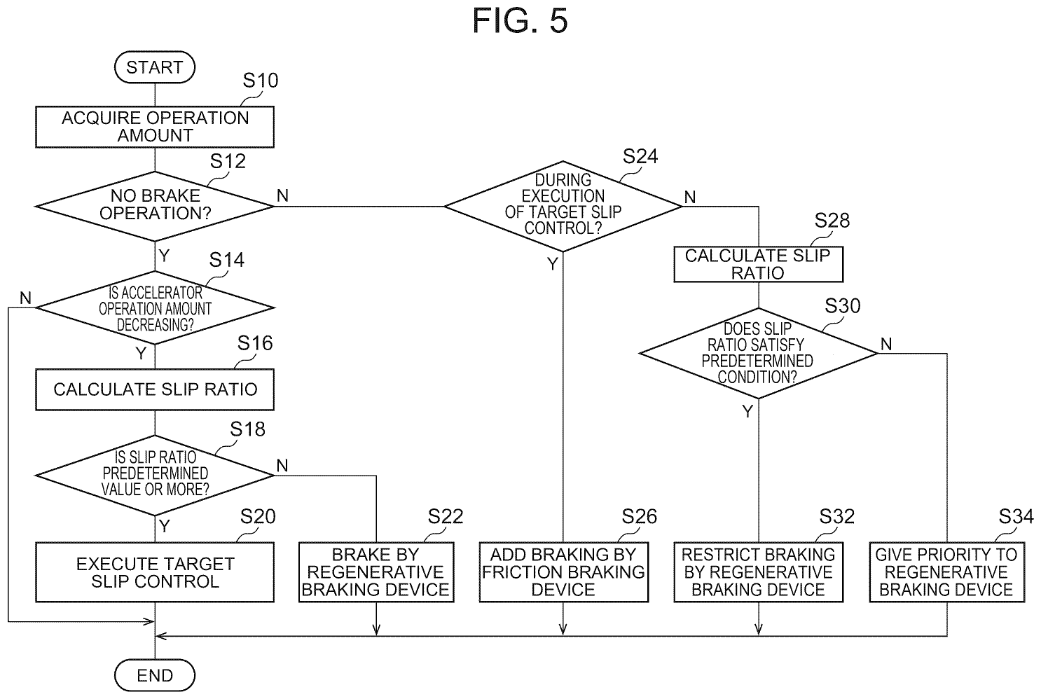

FIG. 5 is a flowchart of a braking control method according to the example. The acquisition unit 24 acquires detection results of the accelerator pedal sensor 12 and the brake pedal sensor 14, and acquires the amount of a pedal operation by a driver (S10). The brake processor 28 determines whether no braking operation is executed (S12).

If no braking operation is executed (Y in S12), the brake processor 28 determines whether the accelerator operation amount is decreasing (S14). If no braking operation is executed and the accelerator operation amount is not decreasing (N in S14), the process ends without performing braking.

If the accelerator operation amount is decreasing (Y in S14), the derivation unit 26 derives the slip ratio of the wheel based on the vehicle speed and the wheel speed (S16). The brake processor 28 determines whether the slip ratio of the wheel is equal to or more than a predetermined threshold value (S18). If the slip ratio of the wheel is equal to or more than the predetermined threshold value (Y in S18), the target slip control is started to apply adjusted accelerator regenerative torque (S20).

If the slip ratio of the wheel is not equal to or greater than a predetermined threshold value (N in S18), constant accelerator regenerative torque is applied by the regenerative braking device 22 (S22), thereby performing so-called coasting.

If the braking operation is executed (N in S12), the brake processor 28 determines whether the target slip control is being executed in the series of braking control (S24). If the target slip control is being executed in the series of braking control (Y in S24), braking caused by the braking operation is executed only by the friction braking device 20 (S26).

If the target slip control is not being executed in the series of braking control (N in S24), the derivation unit 26 calculates the slip ratio of the wheel (S28). The brake processor 28 determines whether the slip ratio of the wheel satisfies a predetermined condition (S30). The predetermined condition may be satisfied if the absolute value of the difference between the slip ratios of the front and rear wheels is equal to or more than a predetermined value, or may be satisfied if the slip ratio of the wheel is equal to or more than a predetermined threshold value.

If the slip ratio of the wheel satisfies a predetermined condition (Y in S30), the brake processor 28 decides to limit the braking amount of the regenerative braking device 22, and the controller 30 controls the braking amount of the regenerative braking device 22 such that the braking amount of the regenerative braking device 22 is equal to or less than a limit value (S32).

If the slip ratio of the wheel does not satisfy the predetermined condition (N in S30), that is, if little slip occurs in the wheel, the brake processor 28 preferentially allocates the regenerative braking device 22, and when the maximum braking amount of the regenerative braking device 22 is exceeded, the friction braking device 20 is controlled to make up for the shortfall (S34).

The present disclosure has been described above based on the example. The present disclosure is not limited to the above example, and various modifications such as design changes may be made based on the knowledge of those skilled in the art.

What is claimed is:

1. A braking control device that controls a regenerative braking device provided for a regenerative braking wheel of any one of a front wheel and a rear wheel, and a friction braking device that is enabled to individually control friction braking force to be applied to each of the front wheel and the rear wheel, the braking control device comprising:
an acquisition unit that acquires a detection result obtained by detecting an accelerator operation amount of an accelerator pedal, a detection result obtained by detecting a braking operation amount of a brake pedal, a detection result obtained by detecting wheel speeds of the front wheel and the rear wheel, and a detection result obtained by detecting a vehicle speed;
a derivation unit that derives a slip ratio of a wheel based on detected wheel speed and vehicle speed;
a brake processor that determines braking amounts to be applied to the regenerative braking device and the friction braking device based on the accelerator operation amount and the braking operation amount; and
a controller that controls the regenerative braking device and the friction braking device based on the determined braking amounts, wherein when the slip ratio increases to be equal to or more than a predetermined threshold value while the accelerator operation amount is decreasing, the controller controls torque of a motor of the regenerative braking device based on a predetermined target slip ratio to execute target slip control of adjusting the slip ratio, and when the target slip control is executed and a braking operation is executed, the controller causes the friction braking device to generate a braking amount corresponding to a braking operation amount.

2. The braking control device according to claim 1, wherein when a braking operation is executed after no target slip control is executed while the accelerator operation amount is decreasing, the brake processor causes the regenerative braking device to be executed according to the braking amount corresponding to the braking operation amount in preference to the friction braking device, and when the braking operation is executed after no target slip control is executed while the accelerator operation amount is decreasing, the brake processor causes control, of limiting the braking amount to be generated by the regenerative braking device, to be executed when the slip ratio satisfies a predetermined condition.

3. The braking control device according to claim 1, wherein when the target slip control is executed and the braking operation is executed, the controller causes the friction braking device that does not correspond to the regenerative braking wheel among the friction braking devices corresponding to the front wheel and the rear wheel to generate a braking amount in preference to the friction braking device corresponding to the regenerative braking wheel.

4. The braking control device according to claim 2, wherein the brake processor sets a value for limiting the braking amount based on a slip ratio of the regenerative braking wheel in control of limiting the braking amount to be generated by the regenerative braking device.

5. A braking control method in which individual steps are executed by a braking control device that controls a regenerative braking device provided for a regenerative braking wheel of any one of a front wheel and a rear wheel, and a friction braking device that is enabled to individually control friction braking force to be applied to each of the front wheel and the rear wheel, the braking control method comprising the steps of:
acquiring a detection result obtained by detecting an accelerator operation amount of an accelerator pedal, a detection result obtained by detecting a braking operation amount of a brake pedal, a detection result obtained by detecting wheel speeds of the front wheel and the rear wheel, and a detection result obtained by detecting a vehicle speed;
deriving a slip ratio of a wheel based on detected wheel speed and vehicle speed;
determining braking amounts to be applied to the regenerative braking device and the friction braking device based on the accelerator operation amount and the braking operation amount; and
controlling the regenerative braking device and the friction braking device based on the determined braking amount, wherein in the step of controlling, when the slip ratio increases to be equal to or more than a predetermined threshold value while the accelerator operation amount is decreasing, torque of a motor of the regenerative braking device is controlled based on a predetermined target slip ratio to execute target slip control of adjusting the slip ratio, and when the target slip control is executed and a braking operation is executed, the friction braking device is caused to generate a braking amount corresponding to the braking operation amount.
